(19) United States
(12) Patent Application Publication
(10) Pub. No.: US 2008/0013587 A1
(43) Pub. Date: Jan. 17, 2008

(54) Multiple-Reflection Delay Line For A Laser Beam And Resonator Or Short Pulse Laser Device Comprising A Delay Line Of This Type

(76) Inventors: Gabriel Tempea, Vienna (AT); Andreas Stingl, Korneuburg (AT)

Correspondence Address: OSTROLENK FABER GERB & SOFFEN, 1180 AVENUE OF THE AMERICAS, NEW YORK, NY, 100368403, US

(21) Appl. No.: 11/576,121

(22) PCT Filed: Sep. 20, 2005
(86) PCT No.: PCT/AT05/00377

§ 371 Date: Mar. 27, 2007

(30) Foreign Application Priority Data
Sep. 28, 2004 (AT) A 1619/2004

(51) Int. Cl. H01S 3/081; G02B 5/08

(52) U.S. Cl. 372/93; 359/584

(57) ABSTRACT

A multiple-reflection delay line member for a laser beam, including mirror elements for the multiple reflection of the laser beam to reduce the dimensions of a laser resonator at a predetermined optical length, wherein the mirror elements are comprised of two oppositely arranged, longitudinally extending polished surfaces of a glass element which extends in one direction and which further comprises a polished laser beam entry surface as well as a polished laser beam exit surface, wherein the mirror element surfaces of the glass element are located between the entry surface and the exit surface and, with the laser beam, form an angle that at least equals the critical angle for total reflection, whereas the entry surface and the exit surface with the laser beam of the glass element define an angle that is smaller than the critical angle for total reflection.

### FIELD OF THE INVENTION

The invention relates to a multiple-reflection delay line member for a laser beam, including mirror elements for the multiple reflection of the laser beam to reduce the dimensions of a laser resonator at a given optical length.

Furthermore, the invention relates to a resonator and a short-pulse laser device including such a delay line member.

### BACKGROUND OF THE INVENTION

In recent years, short-pulse laser devices have gained more and more interest, since they have enabled various applications in research and industry in view of the extremely short pulse durations in the femtosecond (fs) range at pulse peak powers of >1 MW. Short-pulse laser devices of this type having pulse durations in the fs range can, thus, be used for the time-resolved investigation of interactions between electromagnetic radiation and matter. On the other hand, the increasing miniaturization in material processing allows for the manufacture of superfine structures in a precise manner and at high speed. Femtosecond laser devices with high output pulse energies and high repetition frequencies are ideal for this purpose. In this respect, it is desirable to have a laser device which generates laser pulses having pulse durations in the order of 10 fs as well as energies of, for instance, 25 to 30 nJ. Frequently, also relatively slow pulse repetition rates (in the order of 10 MHz instead of, for instance, 80 MHz) are sought for a common titanium sapphire fs-laser, since these will enable higher peak pulse powers or higher pulse energies, which is of interest for material processing. Such comparatively low repetition rates, which, in turn, involve relatively long pulse circulation times in the laser resonator, however, result in a corresponding increase of the resonator length merely by way of calculation.

Basically, it holds that a laser resonator must have a given optical length Lᵣ=c₀/2fᵣ, with c₀=laser light speed, in order to achieve a given repetition frequency fᵣ. This optical length Lᵣ in a femtosecond oscillator, as a rule, is determined by a propagation path comprised of air. In order to reduce the dimensions of a resonator, it has already been proposed to increase in a so-called multiple reflection telescope the pulse circulation time of the laser beam by repeated reflections on oppositely arranged mirrors, cf., e.g., WO 2003/0983134 A2.

Yet, it has been a concern in the construction of laser devices, in particular short-pulse laser devices, even without any special, shortened pulse repetition rate, to achieve compact, small dimensions, wherein the principle of multiple reflections on mirror elements can, of course, be implemented in this case too.

### SUMMARY OF THE INVENTION

It is an object of the invention to provide a multiple-reflection delay line member of the initially defined kind, and a laser resonator and a short-pulse laser device including such a delay line member, with particularly small, compact designs being achievable. The invention is based on the finding that the physical length of a resonator can be reduced, if no air propagation path as is common with conventional short-pulse laser devices is employed, in which the optical length and the physical length are substantially identical, but if a propagation in a medium is used, which has a refraction index higher than air, in which case it will be feasible to indicate the physical length inversely proportionally to this refraction index, i.e. reduce the same. The invention is further based on the principle that the use of such a medium and the presence of interfaces between said medium and the environment (air), with accordingly differing refractive indexes, will allow for a total reflection of the laser beam if the latter impinges on this interface at an accordingly oblique angle. It is known that this critical angle of total reflection on an interface depends on the quotient of the two refractive indexes.

Correspondingly, the multiple-reflection delay line member according to the invention, of the initially defined kind, is characterized in that the mirror elements are comprised of two oppositely arranged, longitudinally extending polished surfaces of a glass element, preferably a glass rod, which extends in one direction and further comprises a polished laser beam entry surface as well as a polished laser beam exit surface, wherein the mirror element surfaces of the glass element are located between the entry surface and the exit surface and with the laser beam form an angle that at least equals the critical angle for total reflection, whereas the entry surface and the exit surface with the laser beam define an angle that is smaller than the critical angle for total reflection.

Such a configuration allows for the realization of the aforementioned object in an advantageous manner, while obtaining a reduction of the physical length, as compared to an air propagation path, corresponding to the quotient 1/n, which is given by the glass refraction index n, as well as, furthermore, corresponding to a factor 1/sin θ₁, wherein the angle θ₁ is that angle under which the laser beam each impinges on the glass element/environment interface, i.e. the plane-polished surface of the glass element; the laser beam is, thus, “delayed” in the glass element in accordance with its multiple reflection and in accordance with the refraction index of the glass material of the glass element, wherein, for instance, in the case of a glass rod having a given length and thickness as well as a given refraction index, an optical path length almost twice as large will be obtained as a function of the incident angle θ₁, what corresponds to a respective temporal delay of the laser beam when travelling through the delay line member, for instance, in the order of 40 ns with a glass rod having a length of about 70 mm. In other words, a straight propagation path in air would have to be almost twice as long as the present delay line member, in order to reach the same delay or same optical path length. Unless only one delay line member is provided, but several delay line members are installed in a laser resonator or laser device, the resonator length or the size of the laser device can be considerably reduced.

For production reasons, and also in order to ensure uniform conditions during total reflection, it is preferably provided that the polished mirror element surfaces of the glass element are parallel with each other. The polished mirror element surfaces of the glass element will then preferably have a relative distance of at least thirty times the mean wavelength of the laser beam in the glass element. This enables the optimization of the number of total reflections in the glass element.

For reasons of symmetry, it will furthermore be favorable if the laser beam entry surface and the laser beam exit surface of the glass element are parallel with each other. The delay line member or component formed by the glass element can thereby be equally operated from either side.

Ultrashort laser pulses with pulse durations in the pico-second and femtosecond ranges, have broad spectra in the frequency range. Pulses with spectra spanning a full optical octave (e.g., between 500 and 1000 nm) have been demonstrated, and short-pulse laser devices delivering pulses with spectral widths of about 200 nm (centered around a mean wavelength of 800 nm) are already commercially available. In order to form a short pulse in the time range, the frequency components of broadband signals have to be in coincidence. Due to the wavelength dependence (which is also referred to as “dispersion”) of the refraction index, different spectral components are differently delayed when travelling through a dense optical medium. In order to describe this effect quantitatively, the group delay dispersion (GDD), in the following briefly referred to as GDD, was introduced as the second derivative of the spectral phase after the circular frequency. The duration of a laser pulse will remain unchanged when travelling through an optical system, if the resulting GDD of the system equals zero. If, however, the system has an overall GDD≠0, the pulse duration at the exit of the optical system will have another value than at its entry. In order to counteract this pulse change, the GDD in the optical system has to be compensated, i.e., a GDD of identical value, yet with an opposite sign has to be introduced. For the realization of such a dispersion compensation, various optical components were developed: prism pairs, grid pairs and dispersive mirrors (cf., e.g., U.S. Pat. No. 5,734,503 A). Thanks to their great bandwidths, user friendliness and compactness, dispersive multilayer mirrors (usually referred to as chirped mirrors—CMs) have been used to an increasing extent for both scientific and industrial applications.

The present optical delay component now has not only enabled a highly effective delay of the laser pulse, but, as a further development of the invention, also rendered feasible the precise and simple control of GDD, wherein it is, in particular, feasible to wholly or partially compensate, or even over-compensate, in an advantageous manner the group delay dispersion introduced by the glass propagation path.

It has already been found that multilayer interference filters can be used to control GDD (cf. Gires F, Tournois P (1964): Interférometre utilisable pour la compensation d'impulsions lumineuses modulées en fréquence. C. R. Hebd. Acad. Sci. 258: 6112-6115). During the reflection on a CM-mirror, the different wavelength components of a laser beam penetrate differently deeply into the layers of the mirror before being reflected. The different frequency components are, thus, delayed for differently long times as a function of the respective penetration depth. Since many optical components have positive GDDs, GDD compensation will in most cases require a negative GDD. In order to obtain a negative GDD, the short-wave wave packets are reflected in the upper layers of a CM mirror, while the long-wave portions will penetrate more deeply into the CM mirror before being reflected. In this manner, the long-wave frequency components are delayed in time relative to the short-wave components, what will lead to the desired negative GDD. However, GDD control is feasible not only with the aid of chirped mirrors (i.e. CM-mirrors), but also with resonator-like multilayer filters (resonance dispersive mirrors), cf. the aforementioned article by Gires F, Tournois P or the documents U.S. Pat. No. 6,222,673 B1, U.S. Pat. No. 6,154,318 A and WO 01/05000 A1. The frequency dependence of the group delay of the beam interacting with the filter in those techniques is controlled through the storage time of the various wave packets in the multilayer structure.

Different design methods and embodiments of dispersive multilayer mirrors have already been proposed. Quasi-analytical methods for calculating the layer thicknesses of a dispersive multilayer (cf., e.g., Matuschek N, Kärtner F X, Keller U (1999): Analytical design of double-chirped mirrors with custom-tailored dispersion characteristics. IEEE J. Quantum Electron. 35: 129-137; Szipöcs R, Köházi-Kis A (1997): Theory and design of chirped dielectric laser mirrors. Appl. Phys. B65: 115-135; Tempea G, Krausz F, Spielmann Ch, Ferencz K (1998): Dispersion control over 150 THz with chirped dielectric mirrors. IEEE JSTQE 4: 193-196; U.S. Pat. No. 6,462,878 B1) have now allowed the design of CM mirrors having bandwidths of up to 400 nm (at mean wavelengths of 780 or 800 nm). Both mirror pairs (Laude V. and Tournois P. (1999): Chirped-mirror-pairs for ultra-broadband dispersion control. In: Conference on Lasers and Electro-optics (CLEO/US), OSA Technical Digest Series, Optical Society of America, Washington, D.C., paper CtuR4 as well as U.S. Pat. No. 6,590,925 B1) and CM-mirrors having wedged front layers (Matuschek N, Gallmann L, Sutter D H, Steinmeyer G, Keller U (2000): Back-side-coated chirped mirrors with ultra-smooth broadband dispersion characteristics. Appl. Phys. B 71: 509-522; Tempea G, Yakovlev V, Bakovic B, Krausz F, Ferencz K (2001): Tilted-front-interface chirped mirrors. JOSA B 18: 1747-1750; as well as WO 02/06899 A2) have rendered feasible GDD control over a full optical octave, e.g. between 500 nm and 1000 nm. All those developments have by the way aimed at expansions of the bandwidths of dispersive mirrors without improving the compactness of the resonators formed with CM mirrors or delay line members. An increasing number of industrial and medical applications have, however, called for the development of extremely compact and stable femtosecond sources.

The present delay line members, which are also referred to as integrated dispersive delay lines (IDDLs), have now enabled the precise control of GDD in combination with a laser source assembly that is substantially more compact than in oscillators using CM-mirrors or prism pairs for GDD control.

A particularly advantageous further development of the delay line member according to the invention is, therefore, characterized in that the glass element, on outer sides of the polished mirror element surfaces, is provided with a multilayer coating that causes a given group delay dispersion (GDD) for the reflected laser beam. The optical delay line members or components according to the invention, on the reflecting surfaces (interfaces) of the glass element, are, thus, provided with multilayer interference filters which introduce group delay dispersions according to the respective wishes in a per se conventional manner. As a rule, a laser system including the usual components like a laser crystal, semitransparent mirrors etc. would have a positive GDD, and in order to enable a compensation in such cases, the coating of the polished surfaces of the glass element of the present delay line member should cause a negative GDD by storing the laser radiation for different wavelengths over differently long periods. In doing so, the reflectivity of the reflecting polished surfaces of the glass element is, however, not changed as opposed to dispersive mirrors or also resonant dispersive mirrors (WO 01/05000 A1). The high reflectivity of these surfaces is provided by the mentioned total reflection, the multilayer interference filters provided by the coatings merely serving to form a given GDD. This is also in contradiction, for instance, to the technique proposed in U.S. Pat. No. 6,256,434 B1, according to which a laser crystal is provided with a multilayer coating on two sides in order to provide a multilayer mirror on the crystal such that the laser beam is “imprisoned” in the crystal, wherein, moreover, a negative GDD is to be created. With the present delay line member, however, the coating merely serves to induce a given GDD, whereas the high reflectivity is obtained by the aid of total reflection, and it is subsequently feasible to introduce comparatively particularly high GDD values by the aid of the multilayer coating so as to enable compact structures for optically long delay lines. This will be demonstrated even more clearly below by way of concrete exemplary embodiments.

The use of said coating enables the introduction of either a constant or a frequency-dependent GDD into the present delay line member. It is, in particular, possible for the introduced GDD to be negative, wherein, in the sense of an overcompensation in order to also compensate for the positive GDD from other parts of the system, its absolute value is, furthermore, larger than the—positive—GDD of the overall path length of the laser beam in the glass element without coating. However, it is, of course, also possible to determine the negative GDD such that its absolute value will virtually exactly equal the positive GDD of the path length in the glass element in order to precisely compensate the GDD of the present delay line component and, thus, obtain an outwardly neutral delay line component in terms of group delay dispersion. Incidentally, it is, of course, also conceivable that the absolute value of the negative GDD introduced by the coating is smaller than the positive GDD of the overall glass path, if this is considered as useful for particular applications.

The glass element may advantageously be made of quartz glass (fused silica), if high quality demands are to be met, yet it may also be made of BK7 glass (a boron crown glass known under that name) or CaF₂ glass (calcium fluoride glass), BK7 glass being advantageous where compactness and robustness are of relevance to the application of the laser device, and CaF₂ glass standing out for its low refraction index and enabling with a given dispersive coating a comparatively high net dispersion of the total delay line.

The laser beam entry and exit surfaces of the glass element together with the laser beam preferably form a Brewster angle, which is known per se. The entry and exit surfaces may, however, also be provided with any other known antireflection coating. It will thereby be feasible to prevent undesired, efficiency-lowering reflections on these surfaces.

The multilayer coating provided on the mirroring, polished surfaces of the glass element may, for instance, be formed with SiO₂ and TiO₂ layers, or with SiO₂ and Ta₂O₅ layers, said materials having turned out to be advantageous in terms of a stable laser beam generation, particularly with applications in multi-photon microscopy, terahertz generation, spectroscopy, but also material processing. Yet, SiO₂ and Nb₂O₅ layers, too, have proved beneficial in terms of a favorable coating technique.

The present delay line member can advantageously be used in laser resonators for short-pulse laser generation and in short-pulse laser devices, wherein it will be of particular advantage if several of such delay line members or delay components are used, since these will enable a particularly compact structure of the resonator and laser device with comparatively extremely small dimensions.

### BRIEF DESCRIPTION OF THE INVENTION

In the following, the invention will be explained in more detail by way of preferred exemplary embodiments, to which it is, however, not limited, and with reference to the drawing. Therein:

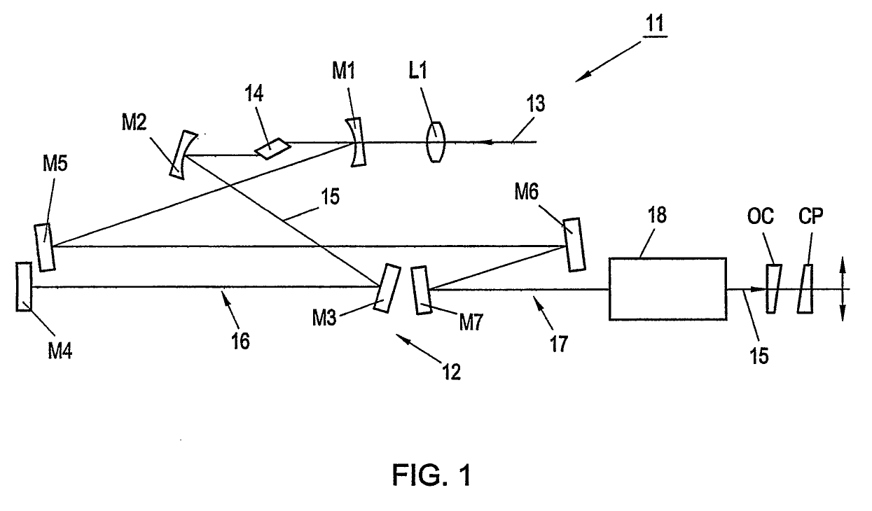

FIG. 1 is a diagrammatic view of the structure of a short-pulse laser device including a very schematically depicted delay line member;

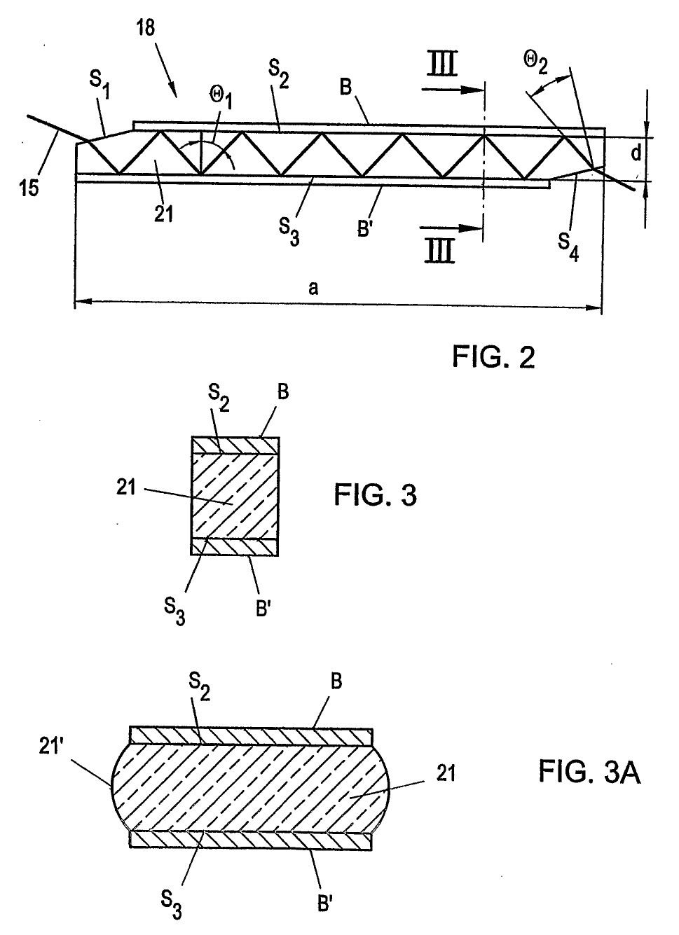

FIG. 2 is a schematic, longitudinal illustration of a delay line member according to the invention;

FIG. 3 depicts a schematic cross-section along line III-III of FIG. 2 through a glass element delay line member of this type;

FIG. 3A is a schematic cross-sectional view similar to FIG. 3, through a modified glass element delay line member;

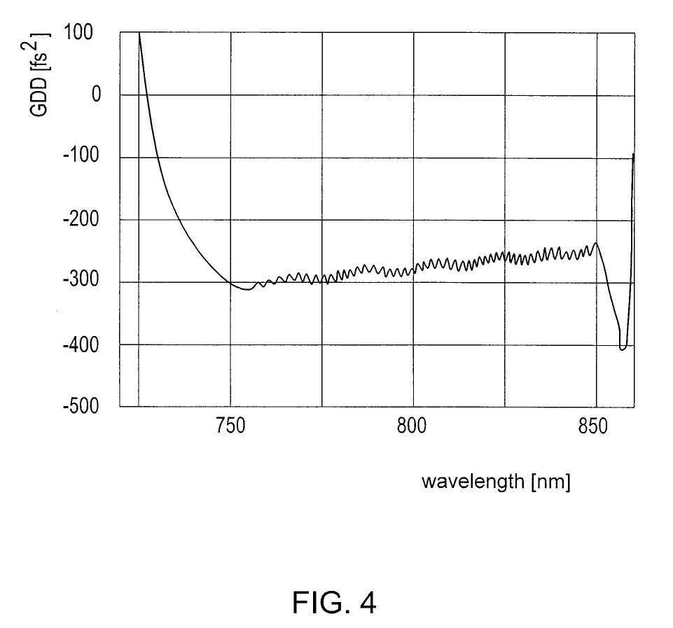

FIG. 4 is a graph illustrating the negative GDD (in fs²) to be attained as a function of the wavelength (in nm) when using such a delay line member with a multilayer coating aimed for GDD compensation; and

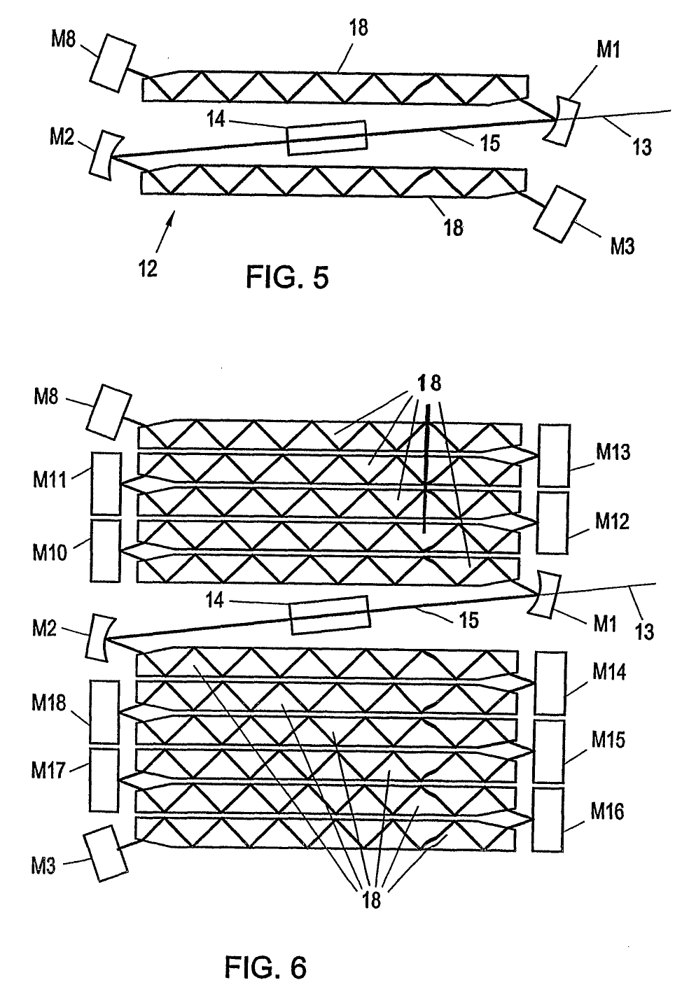

FIGS. 5 and 6 schematically depict two possible arrays of delay line member in laser resonators or short-pulse laser devices.

### DESCRIPTION OF THE INVENTION

FIG. 1 schematically illustrates a conventional short-pulse laser device 11 known per se and implementing, for instance, the Kerr-lens mode locking principle known per se to generate short pulses.

The laser device 11 according to FIG. 1 comprises a resonator 12, to which a pump beam 13, e.g. an argon laser beam, is supplied. The pump laser itself, e.g. an argon laser, has been omitted in FIG. 1 for the sake of simplicity and belongs to the prior art.

After having passed a lens L1 and a dichroic mirror M1, the pump beam 13 excites a laser crystal 14, which is a titanium: sapphire (Ti:S) solid laser crystal in the present example. The dichroic mirror M1 is transparent for the pump beam 13, yet highly reflecting for the Ti:S laser beam 15. Said laser beam 15, i.e. the resonator beam, subsequently impinges on a laser mirror M2 and is reflected by the latter to a laser mirror M3. The laser mirror M3, in turn, reflects the laser beam to a laser mirror M4, from which the laser beam 15 is reflected back to the laser mirrors M3, M2 and M1, passing the laser crystal 14 a second time. This resonator part including mirrors M2, M3 and M4 forms a first resonator arm 16, which is Z-shaped in the illustrated example.

From the mirror M1, the laser beam 15 is then reflected to a laser mirror M5 and, from there, to a laser mirror M6 as well as a further laser mirror M7, thus forming a second resonator arm 17 likewise folded in a Z-shaped fashion. From the laser mirror M7, the laser beam 15 reaches a delay line member 18, which is only schematically entered in FIG. 1, and, from there, to an end mirror OC which functions as an outcoupler. Via said outcoupling end mirror OC, a portion of the laser beam 15 is coupled out while providing a compensation option, wherein a compensation platelet CP as well as a mirror (not illustrated) in thin-layer technique provide for a dispersion compensation and see to it that no undesired reflections will occur in the direction of the laser resonator 12.

The laser crystal 14 is a plane-parallel body, which is optically non-linear and forms a Kerr element, which will have a higher effective optical thickness for higher field strengths of the laser beam 15, but a smaller effective optical thickness if the field strength or intensity of the laser beam is reduced. This Kerr effect, which is known per se, is utilized for the self-focussing of the laser beam 15, i.e., the laser crystal 14 forms a focussing lens for the laser beam 15. Mode locking can, furthermore, be realized in a manner known per se, e.g. by the aid of an aperture (cf., e.g., AT 405 992 B); besides, it would also be conceivable to design one of the end mirrors, e.g. M4, as a saturable Bragg reflector and, hence, use it for mode locking.

Mirrors M1, M2 . . . M7 may be realized in thin-film technique, i.e., they are each constructed of a plurality of layers which fulfil their function during the reflection of the ultrashort laser pulse having a large spectral bandwidth. The various wavelength components of the laser beam 15 penetrate differently deeply into the layers of the respective mirror before being reflected. This causes differently long delays of the various wavelength components on the respective mirror; the shortwave components are reflected farther outwards (i.e. towards the surface), whereas the longwave portions are reflected more deeply in the mirror. This causes the longwave components to be delayed in time relative to the shortwave components. Thus, a dispersion compensation is provided in a known manner in that pulses which are particularly short in the time domain (preferably in the range of 10 femtoseconds and below) possess broad frequency spectra. This is due to the fact that the different frequency components of the laser beam 15 “see” different refraction indexes in the laser crystal 14, i.e. the optical thickness of the laser crystal 14 is differently large for the different frequency components, and the different frequency components are, therefore, differently delayed when travelling through the laser crystal 14. This effect can be overcome by a so-called dispersion compensation on the thin-layer laser mirrors M1, M2 . . . M7.

What has been described so far, is the structure of a short-pulse laser with mode locking, which is conventional per se (cf., e.g., WO 03/098314 A2), and a detailed description of the same is, therefore, not necessary.

As already pointed out above, a portion of the laser pulses is coupled out by the aid of the outcoupler, i.e. end mirror OC, at each circulation of the laser beam 15 during operation. In order to obtain the desired circulation time and, hence, repetition rate even with smaller dimensions of the formed resonator, the “length”, i.e. the optical length, of the laser resonator 12 is increased by the installation of the delay line member 18.

In doing so, multiple reflections are provided, yet in a different manner than with a short-pulse laser device, which, in a known manner, is equipped with a telescope for the delay member (WO 03/098314 A2). The invention utilizes the effect of total reflection, as will be explained below by way of FIGS. 2 and 3, which illustrate an at least presently particularly preferred embodiment of a delay line member 18.

When a light beam (laser beam) passes from an optically denser medium to an optically thinner medium, a total reflection will occur at an accordingly oblique incidence of the beam. Total reflection has already been used in laser devices in order to increase the length of interaction between the laser beam and the laser crystal and to obtain an enhanced beam quality (cf. U.S. Pat. No. 6,658,036 B1 and US 2004/0062284 A1).

The minimum angle for which a total reflection occurs on the interface between two media having refractive indexes nᵢ and nₜ, respectively, is referred to as the critical angle θ_{c} and is expressed by
θ_{c}=arcsin (nₜ/nᵢ).
A laser beam 15, which is coupled into a glass element 21, e.g. a glass rod or a glass platelet, via an oblique entry surface S1 (cf. FIG. 2) in a manner as to form an angle θ₁>θ_{c} with the—preferably parallel—surfaces S2, S3 of the glass element 21, due to total reflection will propagate in the glass element 21 until impinging on an accordingly oblique exit surface S4 at an angle of θ₂<θ_{crit} so as to emerge without any further total reflection. The beam 15, thus, propagates over an optical length L=a/sin (θₛ), which is by a factor 1/sin (θ₁) larger than the physical length a of the glass element 21.

Instead of a glass rod as illustrated in FIG. 3, a glass element having a slightly different shape such as a platelet shape can, of course, be used as said glass element 21, as already indicated above and illustrated in cross section in FIG. 3A. In this case, it is also possible to form the lateral surfaces (on the narrow sides) of the glass element 21 in a bow-shaped rather than straight or rectangular fashion, and on the other hand, also the glass rod glass element 21 illustrated in cross section in FIG. 3 may have accordingly outwardly curved lateral surfaces.

As pointed out above, laser resonators must have a given optical length Lᵣ=c₀/(2fᵣ) in order to reach a given repetition frequency fᵣ. The physical length of a resonator can now be reduced by a factor of about 1.45 (which corresponds to the refractive index of current glasses) relative to a resonator having air propagation paths, in which the optical length and the physical length are practically identical, if the delay line member 18 is not comprised of an air path but formed by the glass element 21. This physical length is reduced according to a further factor 1/sin θ₁, because the beam 15 does not propagate straightly along the glass rod 21, but is reflected to and fro between its surfaces S2, S3 as a result of total reflection, as is schematically illustrated in FIG. 2.

In order to enable the use of such a delay line member 18 for the construction of compact short-pulse laser oscillators (in particular, femtosecond laser oscillators) in an particularly advantageous manner, it should comprise a negative group delay dispersion (GDD) in order to compensate for the positive GDD of the remaining laser components (laser crystal 14, semitransparent mirrors M1, OC, etc.). Optical glasses will, however, introduce positive GDDs at the wavelengths of most of the short-pulse lasers; e.g., most of the current optical glasses would introduce GDDs ranging from 30 fs²/mm to 50 fs²/mm at 800 nm, the mean wavelength of Ti:sapphire lasers. The optical delay line member 18 according to FIGS. 2 and 3, i.e. the glass element 21, is now provided with a multiple interference filter, i.e. a multilayer coating B, B′, on its oppositely located, reflecting surfaces S2, S3: these multilayer coatings B, B′ will cause negative GDDs by “storing” the radiation for different wavelengths over differently long periods of time. Unlike resonant dispersive mirrors (cf., e.g., WO 01/05000 A1), said multilayer interference filters will, however, not change the reflectivity (i.e. reflective capacity) of the surfaces S2, S3. Since the high reflectivity of the surfaces S2, S3 is provided by the described total reflection, the multilayer interference filters B, B′ only serve to induce a given GDD. If the multilayer coatings B, B′ only serve to induce a given GDD (and the high reflectivity is obtained by total reflection), the coatings B, B′ will be able to introduce much higher GDD values, as is indicated by the following example, and, hence, allow for the construction of optically long delay line members of glass without any disadvantages, apart from a GDD compensation for other components of the laser resonator. As indicated by performed calculations, the GDD of the coating B, B′ is, thus, able to partially or wholly compensate, or even overcompensate, a positive GDD of the glass propagation path without any problem.

The example below elucidates such a coating structure, the consecutive coatings, starting on the substrate, i.e. glass rod 21, being indicated by their chemical formulas and layer thick-nesses in nm:

| | |
|---|---|
| Nb₂O₅ | 195.52 |
| SiO₂ | 197.82 |
| Nb₂O₅ | 96.65 |
| SiO₂ | 386.25 |
| Nb₂O₅ | 112.17 |
| SiO₂ | 154.91 |
| Nb₂O₅ | 71.20 |
| SiO₂ | 211.83 |
| Nb₂O₅ | 180.59 |
| SiO₂ | 282.06 |
| Nb₂O₅ | 91.45 |
| SiO₂ | 194.93 |
| Nb₂O₅ | 76.48 |
| SiO₂ | 208.76 |
| Nb₂O₅ | 74.75 |
| SiO₂ | 96.33 |
| Nb₂O₅ | 64.15 |
| SiO₂ | 185.78 |
| Nb₂O₅ | 128.90 |
| SiO₂ | 494.08 |
| Nb₂O₅ | 123.41 |
| SiO₂ | 172.20 |
| Nb₂O₅ | 79.23 |
| SiO₂ | 156.87 |
| Nb₂O₅ | 56.39 |
| SiO₂ | 149.73 |
| Nb₂O₅ | 89.63 |
| SiO₂ | 212.65 |
| Nb₂O₅ | 193.54 |
| SiO₂ | 374.60 |
| Nb₂O₅ | 109.11 |
| SiO₂ | 182.27 |
| Nb₂O₅ | 95.36 |
| SiO₂ | 173.74 |
| Nb₂O₅ | 90.61 |
| SiO₂ | 155.99 |
| Nb₂O₅ | 65.80 |
| SiO₂ | 138.98 |
| Nb₂O₅ | 95.78 |
| SiO₂ | 263.92 |
| Nb₂O₅ | 63.85 |
| SiO₂ | 154.01 |
| Nb₂O₅ | 115.68 |
| SiO₂ | 203.93 |
| Nb₂O₅ | 95.38 |
| SiO₂ | 185.78 |
| Nb₂O₅ | 92.00 |
| SiO₂ | 183.01 |
| Nb₂O₅ | 88.57 |
| SiO₂ | 176.82 |
| Nb₂O₅ | 83.01 |
| SiO₂ | 169.79 |
| Nb₂O₅ | 81.95 |
| SiO₂ | 174.18 |
| Nb₂O₅ | 91.47 |
| SiO₂ | 196.06 |
| Nb₂O₅ | 82.37 |
| SiO₂ | 214.89 |
| Nb₂O₅ | 117.70 |
| SiO₂ | 251.14 |
| Nb₂O₅ | 189.66 |

The layer sequence indicated above causes a GDD of −275 fs² per reflection and compensates (per reflection) the GDD and TOD (third order dispersion—3^{rd} derivative of the spectral phase after the angular frequency) of a propagation path of 7.7 mm quartz glass over a bandwidth of 100 nm. The associated GDD according to FIG. 4 was calculated under the assumption of an incident angle of 45° (>θ₁) on a quartz glass/air interface.

If the delay line member 18 illustrated in FIG. 2 has a thickness d=5 mm and a length a=70 mm, and if the laser beam incident angle θ₁=45°, the total physical path length in the glass rod 21 is approximately 92 mm, which corresponds to an optical path length of about 133 mm and a delay of 44.4 ns. In order to introduce the same delay, a straight propagation path in air would have to be longer by a factor 1.9 as compared to the length a of the integrated delay line member 18. If a laser pulse (in particular a femtosecond laser pulse) propagates in this delay line member 18, the pulse duration on the exit (exit surface S4) of the delay line member 18 will become equal to the entry pulse duration, provided the GDD of the delay line member 18 equals zero over the total spectral width of the pulse. To achieve this, the reflecting surfaces S2, S3 are equipped with the said multiple-interference filter coatings B, B′, which compensate the positive GDD of the glass material of the glass element 21. For the delay line member in FIG. 2, the overall dispersion of the 92 mm long glass path is 3309 fs² (under the assumption that the glass rod 21 is made of quartz glass). The coatings B, B′ provided on the surfaces S2, S3 are, thus, to cause a GDD of about −275 fs² per reflection. A coating comprising the previously exemplified layers and layer thicknesses is able to introduce said GDD (as illustrated in FIG. 4) and to additionally compensate also the dispersion of the third order over 100 nm.

The multilayer coatings B, B′ with the present delay component 18 do not change the reflectivity of the surfaces S2, S3 (which is 100% on account of the total reflection), but merely cause a frequency dependence of the group delay of the reflected light pulses. This will be achieved in that different frequency components have different storage times in the multilayer coating B, B′. It should, however, be once again emphasized that the dispersive coatings provided, as opposed to the dispersive coatings known per se, would not affect the reflectivities of the surfaces S2, S3 on which they are applied, (these reflectivities being already given by the total reflection), but merely change the spectral phases of the reflected pulses.

FIGS. 5 and 6 exemplify the application of the present integrated dispersive optical delay line member in laser oscillators, yet the invention is, of course, not limited to these configurations.

FIG. 5 depicts a laser oscillator, i.e. a resonator 12, which comprises a laser crystal 14, two integrated dispersive delay line members 18 and four mirrors M1, M2, M3, M8. The laser beam 15 derived from the pump beam 13 propagates between the surfaces (S2, S3 in FIGS. 2, 3) of the two delay line members 18 and is focussed or refocussed in the laser crystal 14 by means of two curved mirrors M1 and M2. The mirror M1 has a high transmission at the wavelength of the pump laser (beam 13) and, hence, enables the coupling of the pump beam 13 into the laser crystal 14. The laser crystal 14 is only schematically illustrated in FIG. 5; a crystal whose special geometry permits the formation of a Brewster angle between the laser beam 15 and the crystal surfaces may also be used. The length of the resonator and, hence, the repetition frequency of the laser as well as the stability conditions of the resonator 12 govern the length of the two delay line members 18. One of the two end mirrors M3 or M8 has a low transmission (typically of between 1% and 30%) in the spectral range of the laser beam 15, thus enabling the coupling of an appropriate energy portion of the laser 15 out of the resonator 12.

The laser resonator 12 represented in FIG. 6 differs from the laser illustrated in FIG. 5 in that each resonator arm is made up with several integrated delay line members 18. The mirrors M10 to M18 realize the coupling of a respective delay line member into the consecutive delay line member. The laser beam 15 each again propagates between the surfaces of the delay line members 18 under a multiple total reflection and is focussed or refocussed into the laser crystal 14 by means of two curved mirrors M1 and M2. The mirror M1 has a high transmission at the wavelength of the pump laser and, hence, enables the coupling of the pump beam 13 into the laser crystal 14. The laser crystal 14 is again illustrated only schematically and may be comprised of a crystal whose special geometry permits the formation of a Brewster angle between the laser beam 15 and the crystal surfaces. One of the two end mirrors M3 or M8 has again a low transmission (typically of between 1% and 30%) in the spectral range of the laser beam 15 so as to enable the coupling of an appropriate energy portion of the laser beam 15 out of the resonator 12.

1. A multiple-reflection delay line member for a laser beam, including mirror elements for the multiple reflection of the laser beam to reduce the dimensions of a laser resonator at a predetermined optical length, wherein the mirror elements are comprised of two oppositely arranged, longitudinally extending polished surfaces of a glass element which extends in one direction and further comprises a polished laser beam entry surface as well as a polished laser beam exit surface, wherein the mirror element surfaces of the glass element are located between the entry surface and the exit surface and, with the laser beam, form an angle that at least equals the critical angle for total reflection, whereas the entry surface and the exit surface with the laser beam of the glass element define an angle that is smaller than the critical angle for total reflection.

2. A delay line member according to claim 1, wherein the polished mirror element surfaces of the glass element are parallel with each other.

3. A delay line member according to claim 2, wherein the polished mirror element surfaces of the glass element have a relative distance of at least thirty times the mean wavelength of the laser beam in the glass element.

4. A delay line member according to claim 1, wherein the laser beam entry surface, and the laser beam exit surface, of the glass element are parallel with each other.

5. A delay line member according to claim 1, wherein the glass element, on the polished mirror element surface outer sides, is provided with a multi-layer coating that causes a given group delay dispersion for the reflected laser beam.

6. A delay line member according to claim 5, wherein the group delay dispersion caused by the multilayer coating of the glass element is constant.

7. A delay line member according to claim 5, the group delay dispersion caused by the multilayer coating of the glass element is frequency-dependent.

8. A delay line member according to claim 5, wherein the group delay dispersion caused by the multilayer coating of the glass element is negative and in terms of absolute value is equal to or larger than the positive group delay dispersion of the overall path of the laser beam in the glass element without multilayer coating.

9. A delay line member according to claim 5, wherein the multilayer coating of the glass element is formed with SiO2 and TiO2 layers.

10. A delay line member according to claim 5, wherein the multilayer coating of the glass element is formed with SiO2 and Nb2O5 layers.

11. A delay line member according to claim 5, wherein the multilayer coating of the glass element is formed with SiO2 and Ta2O5 layers.

12. A delay line member according to claim 1, wherein the glass element is made of quartz glass.

13. A delay line member according to claim 1, wherein the glass element is made of BK7 glass.

14. A delay line member according to claim 1, wherein the glass element is made of CaF2 glass.

15. A delay line member according to claim 1, wherein the entry and exit surfaces of the glass element form a Brewster angle with the laser beam.

16. A delay line member according to claim 1, wherein the entry and exit surfaces of the glass element are provided with an antireflection coating.

17. A delay line member according to claim 1, wherein the glass element is comprised of a glass rod.

18. A laser resonator for short-pulse laser generation comprising a laser crystal and laser mirrors as well as at least one delay line member according to claim 1.

19. A short-pulse laser device with preferably passive mode locking, comprising a resonator including a laser crystal and a plurality of laser mirrors, wherein at least one delay line member according to claim 1 is provided in the resonator.
